(19) United States
(12) Patent Application Publication
(10) Pub. No.: US 2025/0329306 A1
(43) Pub. Date: Oct. 23, 2025

(54) INFORMATION PROCESSING SYSTEM, INFORMATION PROCESSING APPARATUS, AND CONTROL METHOD

(71) Applicant: Lenovo (Singapore) Pte. Ltd., Singapore (SG)

(72) Inventors: Ryohta Nomura, Kanagawa (JP); Yoshitsugu Suzuki, Kanagawa (JP)

(73) Assignee: Lenovo (Singapore) Pte. Ltd., Singapore (SG)

(21) Appl. No.: 19/178,105

(22) Filed: Apr. 14, 2025

(30) Foreign Application Priority Data
Apr. 17, 2024 (JP) 2024-067022

(51) Int. Cl. G09G 3/34; G09G 5/36

(52) U.S. Cl. CPC G09G 3/344; G09G 5/36

(57) ABSTRACT

A controller is configured to drive, with 1 bit, pixels arranged in a steady dynamic region in which display content dynamically fluctuates in a steady manner, and drive, with 2 bits or more, pixels arranged in a non-steady dynamic region, for an electrophoretic display panel, and a host system is configured to determine, for an element of a display image to be displayed on a display unit, whether or not to determine a display region of the element as the steady dynamic region based on information on a dynamic characteristic of the element.

### CROSS-REFERENCE TO RELATED APPLICATIONS

This application claims priority to Japanese Patent Application No. 2024-067022 filed on Apr. 17, 2024, the contents of which are hereby incorporated herein by reference in their entirety.

### TECHNICAL FIELD

The present application relates to an information processing system, an information processing apparatus, and a control method, for example, to selection of a driving method for a display device.

### BACKGROUND

An electrophoretic display (EPD) consumes no power while displaying stationary content, and thus is capable of displaying various types of information. The EPD may be used for displaying information primarily in a form of text. For example, Japanese Unexamined Patent Application Publication No. 2015-64421 discloses an application to an electronic book terminal, an electronic medical record, an electronic newspaper, and the like. The EPD is also referred to as an electronic paper display, an electronic ink display, or the like.

However, the EPD has lower responsiveness of display change than other types of display devices, such as a liquid crystal display and an organic light emitting diode display. In particular, when representing gradation with multiple bits, a delay in change tends to be remarkable. In a typical EPD, a response time for 1-bit gradation that displays two levels of gradation is about 100 msec, but a response time for 4-bit gradation that displays 16 levels of gradation reaches 500 msec. In general, in the EPD, the greater the gradation bit depth, the smoother the gradation for displaying an image; however, the responsiveness decreases.

In addition to the above, when the EPD is displayed in 4-bit gradation, in many cases, a process called refresh is required. This is a process of collecting black and white particles moved to an intermediate position at both ends of an electrophoretic electrode once in order to display multi-bit gradation. In this case, white or black display occurs, which is unrelated to the gradation actually required, so that, when displaying video content on the EPD with 4-bit gradation, unnecessary white or black display occurs during the slow response, which is troublesome. When the EPD is displayed in 1-bit gradation, no refresh process is required. For the above reasons, when using an EPD, 1-bit gradation operation is desired for content (videos, Web browsing, and the like) with frequent changes even at the expense of smoothness of gradation, and 4-bit gradation operation is often desired for content (display of photographs and paintings, and the like) with few changes and for which smoothness of gradation is required.

In this regard, when a pixel difference occurs with respect to a previous frame, it is considered to display the pixel in 1 bit, but this may give a strange impression depending on display content. For example, video content may contain a mixture of a portion where there is a pixel difference from the previous frame and a portion where there is no pixel difference, but in this case, in a case where only pixels of the portion where the difference occurs are displayed in 1 bit, a mixture of a 4-bit display portion and a 1-bit display portion is contained in one video, which causes a sense of discomfort. In addition, in a case where a pixel difference of content (for example, a mouse cursor, page switching, and the like) in which a position where a significant difference (hereinafter, referred to as a “pixel difference”) in gradation value occurs between adjacent pixels fluctuates at any time is displayed in 1 bit, a portion after movement is also displayed in 1 bit, resulting in the afterimage becoming visible on a screen, which may give a sense of discomfort to a user. Therefore, there is little significance in changing a drive mode.

### SUMMARY

An information processing system according to a first aspect of the present application includes: a host system; and a display unit, in which the display unit includes a controller and an electrophoretic display panel, the controller is configured to drive, with 1 bit, pixels arranged in a steady dynamic region in which display content dynamically fluctuates in a steady manner, and drive, with 2 bits or more, pixels arranged in a non-steady dynamic region, for the electrophoretic display panel, and the host system is configured to determine, for an element of a display image to be displayed on the display unit, whether or not to determine a display region of the element as the steady dynamic region based on information on a dynamic characteristic of the element.

In the information processing system, the host system may be configured to refer to a list indicating a predetermined application, and, when an application being executed is the predetermined application, determine a display region of an image of the application as the steady dynamic region.

In the information processing system, the host system may be configured to, when an operation indicating a motion operation of the display region is detected, determine the display region as the steady dynamic region.

In the information processing system, the host system may be configured to detect an update region updated from a previous frame from a display image of a current frame, and select, as a candidate for the steady dynamic region, the update region that occurs at a predetermined frequency or more within a predetermined period up to the current frame and that has a common region having a predetermined size or larger.

In the information processing system, the host system may be configured to, when an area ratio of a candidate region that is the candidate for the steady dynamic region to the display image exceeds a predetermined area ratio, determine an entire display image as the steady dynamic region.

In the information processing system, the host system may be configured to, when an area ratio of a stationary update region to a candidate region that is the candidate for the steady dynamic region is equal to or less than a predetermined area ratio of the update region, detect edges from the candidate region, determine an image region whose gradation fluctuates within a predetermined period up to the current frame at a predetermined frequency or more among image regions surrounded by the edges, as the steady dynamic region, and exclude an image region whose gradation does not fluctuate within the predetermined period up to the current frame from the steady dynamic region.

An information processing apparatus according to a second aspect of the present application includes: a host system, in which the information processing apparatus causes a display unit to display a display image, the display unit including a controller configured to drive, with 1 bit, pixels arranged in a steady dynamic region in which display content dynamically fluctuates in a steady manner, and drive, with 2 bits or more, pixels arranged in a non-steady dynamic region, for an electrophoretic display panel, and the host system is configured to determine, for an element of the display image to be displayed on the display unit, whether or not to determine a display region of the element as the steady dynamic region based on information on a dynamic characteristic of the element.

A control method according to a third aspect of the present application is a control method for an information processing system including a host system and a display unit, in which the display unit includes a controller and an electrophoretic display panel, the control method including: via the controller, driving, with 1 bit, pixels arranged in a steady dynamic region in which display content dynamically fluctuates in a steady manner, and driving, with 2 bits or more, pixels arranged in a non-steady dynamic region, for the electrophoretic display panel; and, via the host system, determining, for an element of a display image to be displayed on the display unit, whether or not to determine a display region of the element as the steady dynamic region based on information on a dynamic characteristic of the element.

The above-described aspects of the present application can improve subjective quality of the entire display image depending on display content.

### BRIEF DESCRIPTION OF THE DRAWINGS

FIG. 1 is a schematic block diagram illustrating a hardware configuration example of an information processing system according to one or more embodiments.

FIG. 2 is a schematic block diagram illustrating a functional configuration example of the information processing system according to one or more embodiments.

FIG. 3 is a diagram illustrating a first display example of an image on a display unit.

FIG. 4 is a diagram illustrating a second display example of an image on the display unit.

FIG. 5 is an explanatory diagram illustrating a setting example of a steady dynamic region and a non-steady dynamic region.

FIG. 6 is an explanatory diagram illustrating an outline of a determination method of the steady dynamic region according to one or more embodiments.

FIG. 7 is a diagram illustrating a first example of the determination method of the steady dynamic region according to one or more embodiments.

FIG. 8 is a diagram illustrating a second example of the determination method of the steady dynamic region according to one or more embodiments.

FIG. 9 is a diagram illustrating a third example of the determination method of the steady dynamic region according to one or more embodiments.

FIG. 10 is an explanatory diagram illustrating a size filter.

FIG. 11 is an explanatory diagram illustrating a stability filter.

FIG. 12 is a diagram illustrating a fourth example of the determination method of the steady dynamic region according to one or more embodiments.

FIG. 13 is a diagram illustrating a setting method of the steady dynamic region according to one or more embodiments.

### DETAILED DESCRIPTION

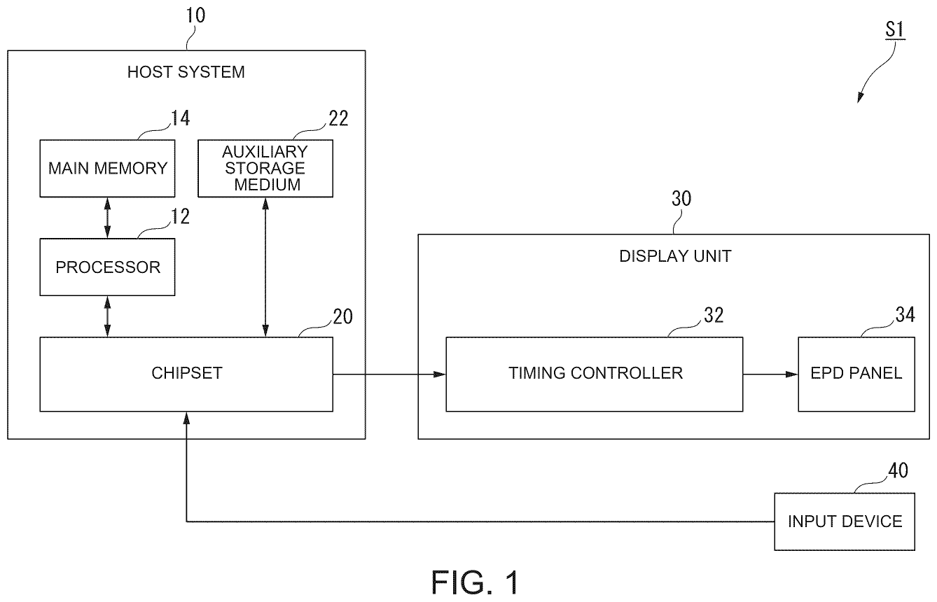

Hereinafter, embodiments of the present application will be described with reference to the drawings. First, a configuration example of an information processing system S1 according to one or more embodiments of the present application will be described. FIG. 1 is a schematic block diagram illustrating a hardware configuration example of the information processing system S1 according to one or more embodiments.

The information processing system S1 includes a host system 10, a display unit 30, and an input device 40. The information processing system S1 may be realized as a single electronic apparatus having all of the host system 10, the display unit 30, and the input device 40. In addition, the information processing system S1 may be configured such that the host system 10 and either or both of the display unit 30 and the input device 40 are separate. The information processing system S1 may be realized as any type of information processing apparatus, such as a personal computer, a tablet terminal, a mobile phone, or an electronic book reader. The host system 10 acquires display data indicating a display image according to various programs, and outputs the acquired display data to the display unit 30. The host system 10 may monitor an operation signal input from the input device 40 and operate based on the input operation signal. In the present application, the operation based on the operation signal input from the input device 40 may be referred to as “operating in response to an operation” or the like.

The display unit 30 is an electronic paper display (EPD) device that displays the display image based on the display data input from the host system 10. The EPD device is an electrophoretic display device having pixels employing an electrophoretic method. The display image, or simply the image, means display content displayed on a screen, that is, a spatial change in brightness or color. The display image includes, as an element, a pattern, a figure, a symbol, a character, or a combination of some or all of these. The display unit 30 has a screen in which pixels are arranged at regular arrangement intervals, and displays the display image based on the display data input from the host system 10 on a display medium. The display unit 30 is capable of displaying the display image in accordance with any of a plurality of predetermined types of drive modes.

A bit depth of a gradation value indicating gradation for each pixel is different depending on the drive mode. The gradation corresponds to a brightness of the pixel, that is, a density or shade. The gradation value is also referred to as a pixel value or a signal value. In particular, the gradation value related to color display is also referred to as a color signal value. The bit depth corresponds to the number of bits representing the gradation value. The greater the bit depth, the wider the range of the gradation value, but the range of the gradation to be represented is common. That is, regardless of the bit depth, the gradation corresponding to the maximum value and the minimum value of the gradation value is common. The greater the bit depth, the smaller a difference in gradation between adjacent gradation values (also referred to as a gradation width). When the bit depth is 1 bit, only two gradations corresponding to first gradation (for example, black in a case of monochrome) corresponding to the maximum value (for example, 1) and second gradation (for example, white) corresponding to the minimum value (for example, 0) are represented. Note that while the greater bit depth allows more levels of gradation to be represented, the responsiveness of the pixel decreases. When the pixels are driven with a bit depth greater than 2 bits, the refresh process is required for every predetermined refresh cycle.

The input device 40 is capable of receiving an operation of the user, and generates an operation signal in response to the received operation. The input device 40 outputs the generated operation signal to the host system 10. As the input device 40, for example, a general-purpose device such as a touch sensor, a mouse, a keyboard, or a joystick may be used, or a dedicated device such as a button, a knob, or a dial may be used. The touch sensor applied as the input device 40 may be integrated with an electrophoretic display (EPD) panel 34 of the display unit 30 and configured as a touch panel.

As will be described below, the host system 10 according to one or more embodiments specifies, as a steady dynamic region, a region in which an image constituting display content steadily fluctuates over time within the display image displayed on the display unit 30. In general, an image is represented by a distribution of gradation values for pixels arranged adjacent to each other at different positions, that is, a gradation distribution. The image fluctuation is represented by a change in gradation distribution between frames. The host system 10 notifies the display unit 30 of the display image and the specified steady dynamic region. The display unit 30 displays the display image in the steady dynamic region notified by the host system 10 by using a drive mode having higher responsiveness than a drive mode for a non-steady dynamic region as the other region. While a decrease in image quality is allowed for the steady dynamic region, responsiveness is required. While a decrease in responsiveness is allowed for the non-steady dynamic region, high image quality is required. Therefore, it is possible to achieve both quality and responsiveness for the entire display image, thereby improving subjective quality.

Next, the hardware configuration example of the information processing system S1 will be described.

The host system 10 includes a processor 12, a main memory 14, a chipset 20, and an auxiliary storage medium 22. The host system 10 controls functions of the entire information processing system S1.

The processor 12 controls functions of the entire apparatus including the host system 10. As the processor 12, for example, one or more central processing units (CPUs) may be applied. The processor 12 executes a predetermined program and cooperates with a part or all of the main memory 14, the chipset 20, the auxiliary storage medium 22, and other hardware to perform functions of the host system 10.

In the present application, execution of processing instructed by a command written in a program via the processor 12 or other hardware may be referred to as “execute a program”, “execution of a program”, or the like.

The main memory 14 is a writable memory that is used as a work area of the processor 12, that is, a reading area for a program to be executed and various kinds of setting data, and a writing area for processing data acquired by executing the program. The main memory 14 includes, for example, a plurality of dynamic random access memory (DRAM) chips. The program to be executed includes an operating system (OS), various device drivers for controlling peripheral devices and the like, various services/utilities, an application program (in the present application, may be referred to as an “app”), and the like.

The processor 12 and the main memory 14 function as the minimum system device that forms the host system 10. The host system 10 includes a system device as hardware, and software such as an OS and a schedule task.

The chipset 20 includes one or a plurality of controllers, and is connectable to the display unit 30 and other devices so as to input and output various types of data. The chipset 20 is also referred to as a platform controller hub (PCH). The chipset 20 has, for example, any one or a combination of a plurality of bus controllers such as a universal serial bus (USB), a serial advanced technology attachment (ATA), a serial peripheral interface (SPI) bus, a peripheral component interconnect (PCI) bus, a PCI-Express bus, and a low pin count (LPC).

The auxiliary storage medium 22 stores various programs and data. The various programs include, for example, firmware, a device driver, a service/utility, an app, and the like. These programs are executed by the processor 12. The data to be stored includes data to be processed by the processor 12 and data generated or input by processing. The auxiliary storage medium 22 includes a non-volatile memory such as a flash memory. As the auxiliary storage medium 22, a solid state drive (SSD), a hard-disk drive (HDD), or the like may be used.

The display unit 30 includes a timing controller (T-CON) 32 and the EPD panel 34.

The display data is input to the timing controller 32 in accordance with an input/output method defined in a predetermined input/output standard from the host system 10. As the input/output method, for example, a method defined by any of a display (DP) standard, a mobile industry processor interface (MIPI) standard, a high-definition multimedia interface (HDMI) (registered trademark) standard, and the like may be used. The timing controller 32 quantizes a gradation value of each pixel indicated by the input display data at a bit depth corresponding to the drive mode and converts the gradation value into a quantized value. The timing controller 32 generates a drive signal indicating gradation of each pixel in accordance with a display timing of the EPD panel 34 in order to display each pixel in gradation corresponding to the converted quantized value. The timing controller 32 outputs the generated drive signal to the EPD panel 34. The timing controller 32 performs the refresh process at a predetermined refresh rate depending on the drive mode, and determines the gradation value to a predetermined reference value (for example, the minimum value). The timing controller 32 may include, for example, a computing circuit configured of an application specific integrated circuit (ASIC), a field programmable gate array (FPGA), or the like, and may execute a rewritable program to realize its functions, or may be realized by dedicated hardware.

The EPD panel 34 has a substrate, a plurality of pixels, and a drive circuit. The drive circuit applies a voltage corresponding to the specified gradation to a pixel corresponding to a timing specified by the drive signal input from the timing controller 32. The drive circuit includes, for example, a transistor-transistor logic (TTL) circuit. A plurality of pixels is periodically two-dimensionally arranged on a surface of the substrate. Each pixel represents gradation corresponding to the voltage applied from the drive circuit. Each pixel has a pair of electrodes and is configured to hold a solution therebetween. Charged particles made of a pigment are suspended in the solution. The charged particles move toward an electrode having a different polarity from the charged particles in accordance with the applied voltage. This movement causes a change in gradation.

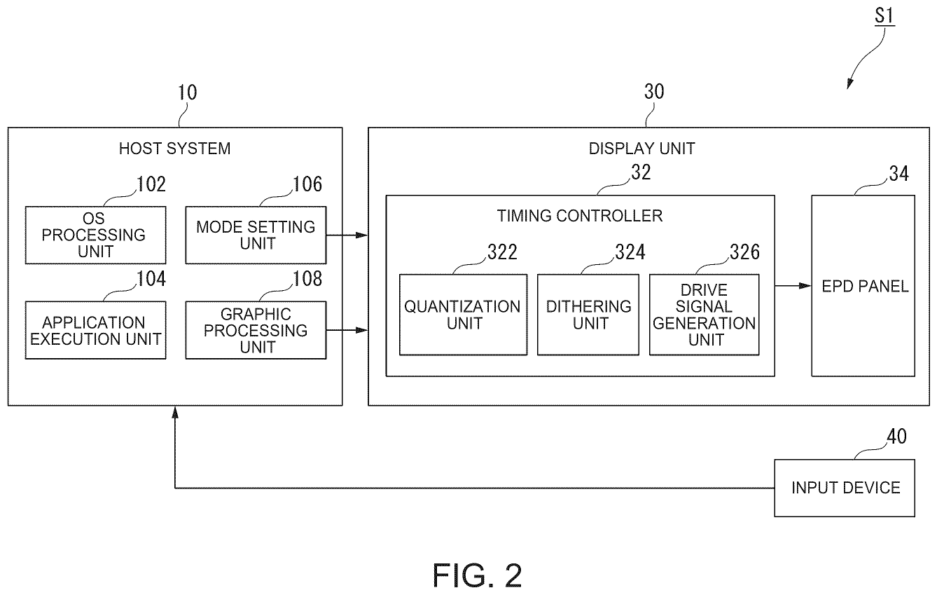

Next, a functional configuration example of the information processing system S1 will be described. FIG. 2 is a schematic block diagram illustrating the functional configuration example of the information processing system S1 according to one or more embodiments.

The host system 10 includes an OS processing unit 102, an application execution unit 104, a mode setting unit 106, and a graphic processing unit 108.

The OS processing unit 102 executes an OS and provides its functions. In the present application, execution of an OS and other programs means executing processing instructed by various commands written in the programs. The functions of the OS include management of resources used for computation processing, storage of data, and the like, provision of a standard interface for an application program (in the present application, may be referred to as an “application” or an “app”) or a user, and the like. The OS processing unit 102 executes, for example, starting-up of an application, monitoring of an execution state of the application after the application is started up, setting of a display region for an application image, priority control for components of a display image, cursor display, and the like.

The OS processing unit 102 starts up an application specified by an operation signal in response to an operation, and starts its execution. The OS processing unit 102 may start execution of an application whose use environment satisfies a predetermined start-up condition. As the start-up condition, for example, a current time point reaching a predetermined start-up time point (start-up timer) may be applied. The application image refers to a display image acquired by processing an application being executed. The application image is configured to be accommodated in a rectangular window (in the present application, may be referred to as an “application window”). In response to an operation, the OS processing unit 102 executes designation of an application window to be focused on as a display target, change of a size of the application window or a position of the application window on the display image, erasure, redisplay, and the like. The OS processing unit 102 displays an application image whose display is started later or an application image operated later among a plurality of application images with higher priority. When a certain application image is displayed with priority, the OS processing unit 102 displays, in a shared region of the certain application image that is shared with other application images, content of the shared region of the certain application image, and does not display content of the shared region of the other application images, which is equivalent to rejection.

The OS processing unit 102 executes various kinds of screen display as the processing instructed by the OS. Various screen components (that is, user interface (UI) components) are used in the screen display. The OS processing unit 102 displays a cursor at a position on the display image specified in response to an operation. When a position in the region of the application image is specified in response to an operation, the OS processing unit 102 executes a function of the application corresponding to the position (for example, turning on or off a specific function by pressing a button, and the like). When a position outside the region of the application image is specified in response to an operation, the OS processing unit 102 executes an OS-specific function corresponding to the position (for example, movement of a data file through a drag operation, and the like). The OS processing unit 102 configures a display image to be displayed on the display unit 30 by superimposing an element image provided by the OS-specific function and the application image currently being executed with a predetermined priority.

The application execution unit 104 executes an application that is instructed to be started up by the os processing unit 102. The application execution unit 104 configures a display image to be displayed as a function in the processing of the application. For example, a video playback application configures a display image forming a video that is instructed to be played. The configured display image is accommodated in an application window assigned to the application.

The mode setting unit 106 specifies the steady dynamic region from the display image displayed on the display unit 30 and distinguishes the steady dynamic region from the other region, that is, the non-steady dynamic region. The mode setting unit 106 monitors a gradation distribution in the display image or an occurrence status of information that may be a variable factor of the gradation distribution for each frame at different time points. The mode setting unit 106 determines, for example, a region in which portions where fluctuations in gradation distribution occur at a predetermined frequency or more in a predetermined period up to the current time are spatially connected, as the steady dynamic region. For example, when the gradation distribution does not fluctuate in the steady dynamic region in the predetermined period up to the current time, the mode setting unit 106 changes the region to the non-steady dynamic region. As will be described below, the mode setting unit 106 generates a drive command including setting information indicating a portion occupied by the steady dynamic region in the display image. The mode setting unit 106 outputs the generated drive command to the display unit 30. As a result, the image is displayed in the steady dynamic region using a different drive mode from the non-steady dynamic region. An example of a determination method of the steady dynamic region will be described below.

The graphic processing unit 108 recognizes the display unit 30 connected to the host system 10. The graphic processing unit 108 generates display data indicating the display image configured by the OS processing unit 102 for each frame. The display image of one frame is represented by a gradation value of each pixel. A bit depth of the gradation value is, for example, 8 to 10 bits. The graphic processing unit 108 outputs the generated display image to the display unit 30 and displays the display image. Functions of the graphic processing unit 108 may be realized by executing a graphics driver bundled with the OS, or may be realized by executing a device driver dedicated to the display unit 30.

Next, a functional configuration example of the timing controller 32 will be described.

The timing controller 32 includes a quantization unit 322, a dithering unit 324, and a drive signal generation unit 326.

The quantization unit 322 includes a frame buffer (not illustrated). The display data input from the host system 10 is temporarily stored in the frame buffer, and, each time new display data is input, the stored display data is updated to the new display data.

The quantization unit 322 extracts setting information from the drive command input from the host system 10, specifies the steady dynamic region indicated by the extracted setting information, and specifies a region outside the steady dynamic region as the non-steady dynamic region. The quantization unit 322 sets a drive mode having higher responsiveness than the drive mode for the non-steady dynamic region as the drive mode for the steady dynamic region. The quantization unit 322 sets, for the steady dynamic region, a bit depth (for example, 1 bit) smaller than a bit depth (for example, 4 bits) for the non-steady dynamic region.

The quantization unit 322 reads out the gradation value of each pixel arranged in the steady dynamic region and the non-steady dynamic region from the frame buffer, in a shorter period as the set bit depth is smaller.

The quantization unit 322 converts the gradation value of each pixel into a quantized value by quantizing the gradation value at a bit depth specified in a drive mode set for a region to which the pixel belongs.

The quantization unit 322 notifies the dithering unit 324 of the quantized value of each pixel belonging to a region with a bit depth of 1 bit, together with the setting information and the display data.

For a region with a bit depth of 2 bits or more, the quantization unit 322 notifies the drive signal generation unit 326 of the quantized value of each pixel belonging to the region. This is because dithering is not performed on the region. Note that the quantization unit 322 performs the refresh process on the pixels in the region for every predetermined refresh cycle. The refresh cycle may be set to be longer as the drive mode has a greater bit depth. In the refresh process, the quantization unit 322 sets a quantized value of each pixel to a predetermined reference value (for example, a quantized value corresponding to the maximum gradation or the minimum gradation) and then restores the quantized value to the original quantized value. Each time the quantized value is changed, the quantization unit 322 notifies the drive signal generation unit 326 of the quantized value after the change.

The dithering unit 324 performs dithering in the dynamic region specified by the mode setting unit 106 to quantize the display data and spatially disperse a quantization error generated by the quantization. The dithering unit 324 specifies the steady dynamic region based on the setting information notified by the quantization unit 322. For example, the dithering unit 324 calculates a difference between a gradation value before quantization and a quantized value for each pixel in the dynamic region as the quantization error, and disperses the calculated quantization error to the surrounding pixels. The dithering does not necessarily have to be executed. For example, the need for dithering is low for content with only black or white gradation such as text.

As a method of dispersing the quantization error, for example, any method such as matrix computation using a Floyd-Steinberg matrix, matrix computation using an Atkinson matrix, or a minimized average error method may be employed. With the matrix computation, a quantization error of a target pixel to be computed is assigned to an unprocessed pixel as an unprocessed dispersion destination at a predetermined ratio for each method and added to the gradation value. The target pixel is changed to an unprocessed adjacent pixel each time single matrix computation is performed, so that, for the unprocessed pixel, the gradation value before quantization and the quantized value obtained by quantizing the gradation value are not finally determined until the unprocessed pixel becomes the target pixel. The dithering unit 324 employs the quantized value finally obtained by the process of S01 in each pixel in the steady dynamic region and updates the original quantized value to the newly employed quantized value. The dithering unit 324 notifies the drive signal generation unit 326 of the quantized value of each pixel including the updated quantized value.

The drive signal generation unit 326 generates a drive signal having a voltage corresponding to the quantized value of each pixel notified by the quantization unit 322 or the dithering unit 324. The drive signal generation unit 326 outputs, at a different timing for each pixel in a frame cycle, a drive signal having a voltage set for the pixel to the EPD panel 34. A voltage set for each pixel is applied to the EPD panel 34, and display is made with gradation corresponding to the applied voltage.

In the timing controller 32, the dithering unit 324 may be omitted. In this case, the quantized value of each pixel obtained in the quantization unit 322 is notified to the drive signal generation unit 326 and is used for the generation of the drive signal.

Next, a display example of an image on the display unit 30 will be described.

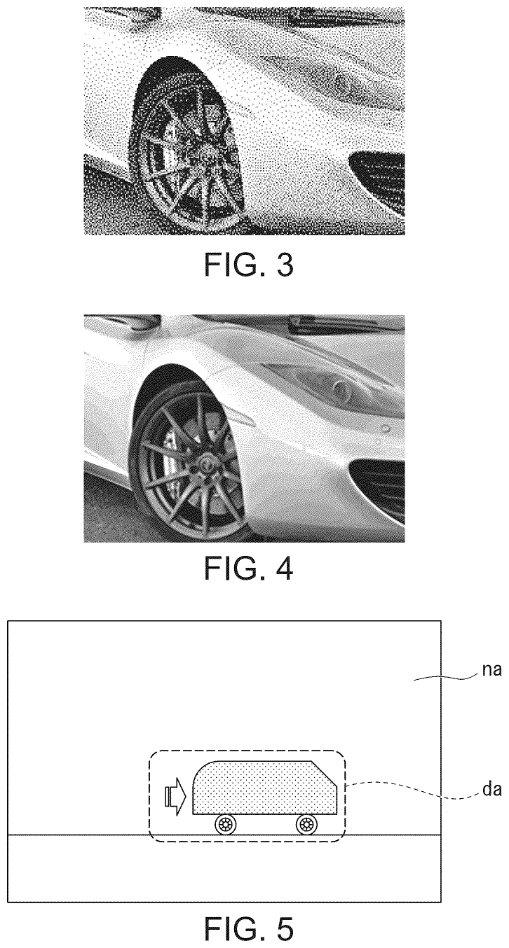

FIG. 3 illustrates an image displayed in a drive mode as a 1-bit mode, and FIG. 4 illustrates an image displayed in a drive mode as a 4-bit mode. The 1-bit mode is a drive mode in which the gradation value is quantized in 1 bit and the 4-bit mode is a drive mode in which the gradation value is quantized in 4 bits. More subtle gradation changes are represented in FIG. 4 than in FIG. 3. In the 1-bit mode, the represented gradation has only the maximum value and the minimum value, so that a spatial distribution of the gradation is represented by a ratio of a pixel having the maximum value to a pixel having the minimum value through the dithering. However, since the spatial distribution of the gradation can only be represented in a region significantly larger than a pixel interval, the image quality is deteriorated compared to the 4-bit mode. On the other hand, since the 1-bit mode has higher responsiveness than the 4-bit mode, the 1-bit mode is also capable of responding to updates with a higher frequency without requiring the refresh process.

Therefore, the quantization unit 322 according to one or more embodiments sets a drive mode having higher responsiveness than the drive mode for the non-steady dynamic region, for the steady dynamic region. The host system 10 determines a region in which portions where a change in gradation distribution occurs at a predetermined frequency or more within a predetermined period up to the current time are spatially connected as the steady dynamic region, and determines the other region as the non-steady dynamic region. Therefore, a method with higher responsiveness than the non-steady dynamic region is set for the steady dynamic region in which the change in gradation or the movement of the image frequently occurs. For example, in the example of FIG. 5, a region including a portion where an image of a moving vehicle appears at the current time and a portion where the image of the vehicle has passed immediately before that time is set as a steady dynamic region da, and a region around the steady dynamic region da is set as a non-steady dynamic region na.

In the steady dynamic region, a time-dependent change in image is allowed, and a decrease in image quality due to a coarse gradation width is allowed. In the non-steady dynamic region, a decrease in image quality is suppressed by a fine gradation width, and a time-dependent change in image is not required. Therefore, the subjective quality of the image represented by the display unit 30 is improved as compared with a case where the entire display image is represented in one drive mode.

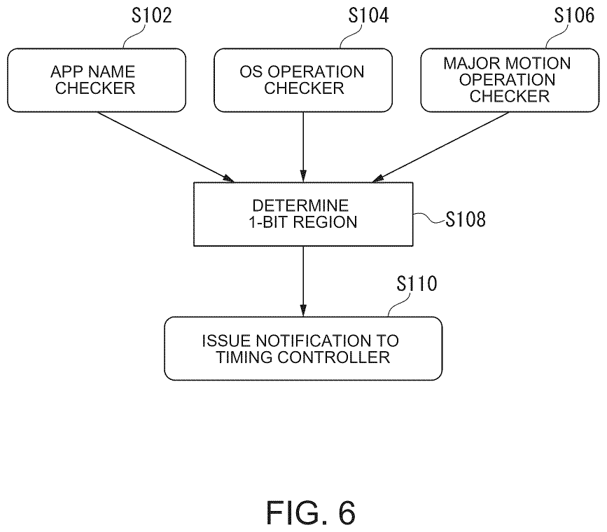

Next, a specific example of the determination method of the steady dynamic region will be described. In the following description, a case where the 1-bit mode is set in the steady dynamic region and the 4-bit mode is set in the non-steady dynamic region will be exemplified. The steady dynamic region is referred to as a “1-bit region”, and the non-steady dynamic region is referred to as a “4-bit region”. FIG. 6 is an explanatory diagram illustrating an outline of the determination method of the steady dynamic region according to one or more embodiments.

(Step S102) The mode setting unit 106 of the host system 10 monitors the presence or absence of an application that is instructed to be started up, as notified by the OS processing unit 102. The mode setting unit 106 determines whether or not an application newly instructed to be started up is an application related to the 1-bit display based on whether or not a name of the application is included in a 1-bit app list set in advance in the mode setting unit 106 (App name checker). In the 1-bit app list, a name of an application that issues an instruction of image display in the 1-bit mode (hereinafter, may be referred to as a “1-bit app”) is set in advance. The 1-bit app may be, for example, an application for video playback, an application for image editing or image creation, or the like.

(Step S104) The mode setting unit 106 monitors an operation of the OS notified by the OS processing unit 102 (OS operation checker). The operation of the OS refers to the display of an image or its fluctuation caused by the execution of the OS. For example, there are display of a window that accommodates an element image that is an element of a display image, movement or deformation of the window, display of a cursor related to an operation, movement of the cursor, and the like.

(Step S106) The mode setting unit 106 monitors a main fluctuation state of the element image that is an element of the display image (major motion operation checker). The element image includes, for example, a video image or an animation image included in an application image specified by an application, and the like. As the main fluctuation state, a frequency of fluctuations within a predetermined period up to the current time and the stability of a region in which the fluctuations occur are listed.

(Step S108) The mode setting unit 106 determines the 1-bit region based on a detection result of any one step of steps S102 to S106 or any combination of steps. (Step S110) The mode setting unit 106 notifies setting information indicating the determined 1-bit region to the timing controller 32 of the display unit 30.

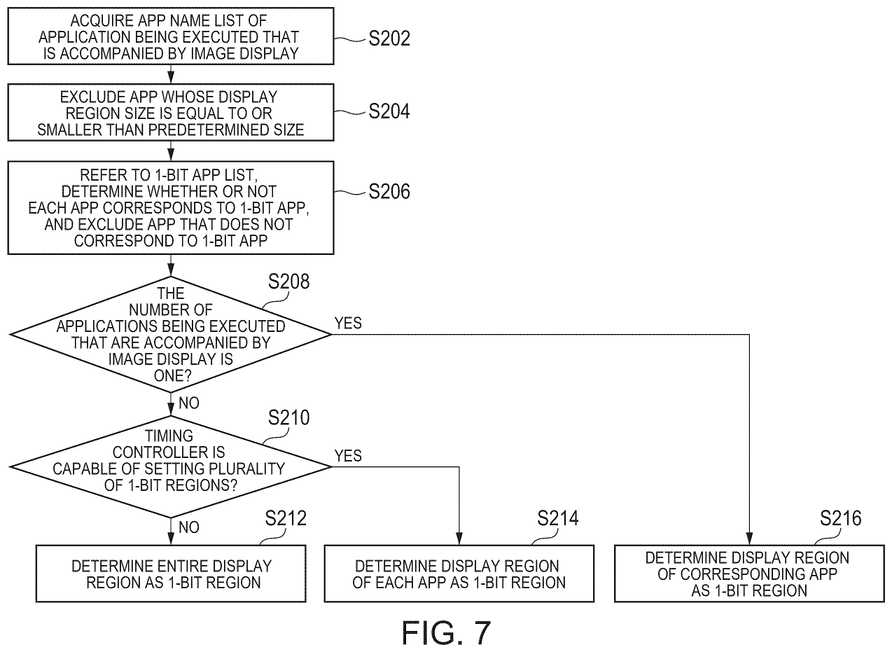

Next, a specific example of the determination method of the steady dynamic region according to one or more embodiments will be described. FIG. 7 is a diagram illustrating a first example of the determination method of the steady dynamic region according to one or more embodiments. The method illustrated in FIG. 7 corresponds to a specific example of the determination method based on the app name checker.

(Step S202) The mode setting unit 106 acquires an app name list from the OS processing unit 102. The app name list includes a name of each application that is being executed in the os processing unit 102 and that is accompanied by image display, and information on a display region of the application.

(Step S204) The mode setting unit 106 excludes a display region of an application whose display region size is a predetermined size (for example, 200×200 pixels to 400×400 pixels) from candidates for the steady dynamic region.

(Step S206) The mode setting unit 106 refers to the 1-bit app list set in advance in the mode setting unit 106, determines whether or not each application notified in the app name list corresponds to the 1-bit app, and excludes a display region of an application that does not correspond to the 1-bit application from the candidates for the steady dynamic region.

(Step S208) The mode setting unit 106 determines whether or not the number of applications being executed that are not excluded and remain and that are accompanied by the image display is one. When it is determined that the number is one (YES in step S208), the process proceeds to step S216. When it is determined that the number is two or more (NO in step S208), the process proceeds to step S210.

(Step S210) The mode setting unit 106 determines whether or not the timing controller 32 of the display unit 30 connected to the mode setting unit 106 is capable of setting a plurality of 1-bit regions in the display region. For example, at a time of the detection with the display unit 30 or the timing controller 32, the mode setting unit 106 is capable of determining whether or not a model notified by device information input from the display unit 30 or the timing controller 32 includes a model written in advance in a set model list, thereby determining whether or not the model is capable of setting a plurality of 1-bit regions. Being capable of setting a plurality of 1-bit regions corresponds to whether or not there is an ability to realize quantization of gradation values with different bit depths independently for each of a plurality of partial regions included in the display region. When it is determined that the setting is possible (YES in step S210), the process proceeds to step S214. When it is determined that the setting is not possible (NO in step S210), the process proceeds to step S212.

(Step S212) The mode setting unit 106 sets the entire display region as a 1-bit region.

(Step S214) The mode setting unit 106 sets the display region for each application being executed as a 1-bit region, and sets the other regions as a 4-bit region.

(Step S216) The mode setting unit 106 sets the display region of one application as a 1-bit region, and sets the other regions as a 4-bit region. Then, the processing in FIG. 7 ends.

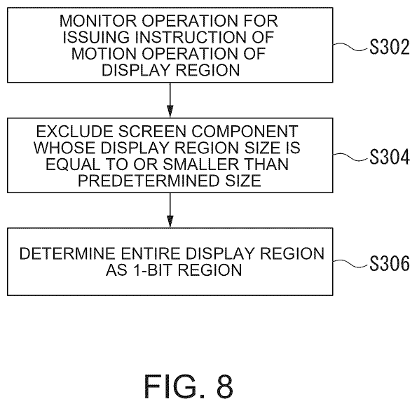

FIG. 8 is a diagram illustrating a second example of the determination method of the steady dynamic region according to one or more embodiments. The method illustrated in FIG. 8 corresponds to a specific example of the determination method based on the OS operation checker.

(Step S302) The mode setting unit 106 monitors a user operation for issuing an instruction of a motion operation of the display region in the processing of the OS processing unit 102. The motion operation of the display region includes, for example, any one of the following items, such as movement and size or shape change of a screen component displayed by the OS, or any combination of a plurality of these items. The screen component to be monitored includes a window, a cursor, an icon, and the like.

(Step S304) The mode setting unit 106 excludes a screen component whose display region size is equal to or smaller than a predetermined size (for example, 200×200 pixels to 400×400 pixels) from evaluation targets (size filter). By excluding relatively small screen components from the evaluation targets, screen components that have a high influence on the user's visibility are left.

(Step S306) When a screen component for which a user operation for issuing an instruction of a motion operation of the display region is issued is detected, the mode setting unit 106 determines the entire display region as a 1-bit region. Then, the processing in FIG. 8 ends.

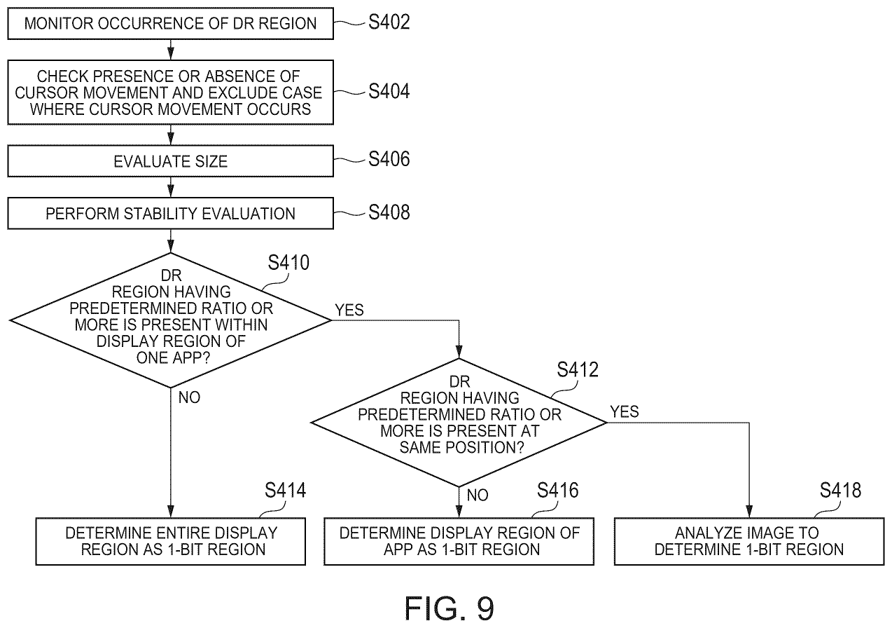

FIG. 9 is a diagram illustrating a third example of the determination method of the steady dynamic region according to one or more embodiments. The method illustrated in FIG. 9 corresponds to a specific example of the determination method based on the major motion operation checker. This method aims to detect a region where a change in gradation distribution occurs steadily (that is, continuously for a predetermined time or longer) in the same location. Therefore, simply setting a region where a difference occurs between the previous frame and the current frame as the steady dynamic region may not suffice to address the issue. For example, when a cursor is moved by a user operation or when a part of a video image is changed, a difference in display aspect from the surroundings may cause a sense of discomfort. In addition, when a page is switched, the display content is largely changed before and after the switching, so that the effect of switching the drive mode is not achieved. For example, even in a case where the drive mode is maintained in the 4-bit mode, the entire display region is rewritten by refreshing. With respect to this, even in a case where the drive mode is changed from the 4-bit mode to the 1-bit mode to rewrite the display image and then returned to the 4-bit mode, there is no change in the point that the display image is rewritten.

In this example, the mode setting unit 106 acquires an update region indicating the movement of the gradation or the image from the previous frame to the current frame. The mode setting unit 106 uses, for example, a dirty rectangle (DR) region generated by a function of Windows (registered trademark) as the update region. The DR region is a rectangular region including a pixel where a pixel change has occurred, and therefore does not necessarily coincide with a region in which a video image is actually displayed. In addition, depending on the OS specification, the DR region may be generated even in a case where a screen is not actually changed. For example, a transparent window that is not actually displayed (hereinafter, referred to as a “transparent window”) may be temporarily generated to organize the order of display objects, and a region of the transparent window may be reported as the DR region. Therefore, the mode setting unit 106 evaluates the stability of the DR region and employs the DR region that is determined to be stable. In addition, the display region of the video image is not capable of being specified only by a simple fluctuation in gradation value of each pixel from the previous frame to the current frame. Therefore, the mode setting unit 106 detects edges that appear steadily in the display image. The mode setting unit 106 detects a fluctuation in gradation distribution in the image region surrounded by the detected edges.

(Step S402) The mode setting unit 106 monitors the DR region detected by the OS processing unit 102.

(Step S404) The mode setting unit 106 determines whether or not a cursor displayed at the current time is being moved. When the cursor is being moved, the processing in FIG. 9 is ended without executing the processes in step S406 and subsequent steps. This is because the movement of the cursor indicates the occurrence of a user operation, and a user's attention is therefore relatively focused on the operation, so that it is considered that the impact on visibility is small.

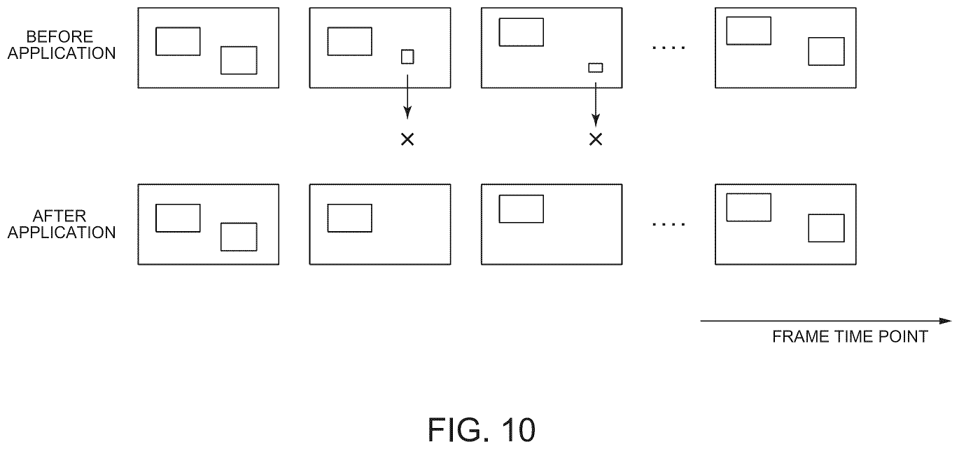

(Step S406) The mode setting unit 106 performs size evaluation on each DR region (size filter). In the size evaluation, a DR region whose size is equal to or smaller than a predetermined size (for example, 200×200 pixels to 400×400 pixels) in frames within a predetermined period (for example, the most recent 5 to 15 frames) up to the current time is excluded from the next stability evaluation targets. In the example of FIG. 10, the DR region in a lower right corner appearing in second and third frames of the period is excluded.

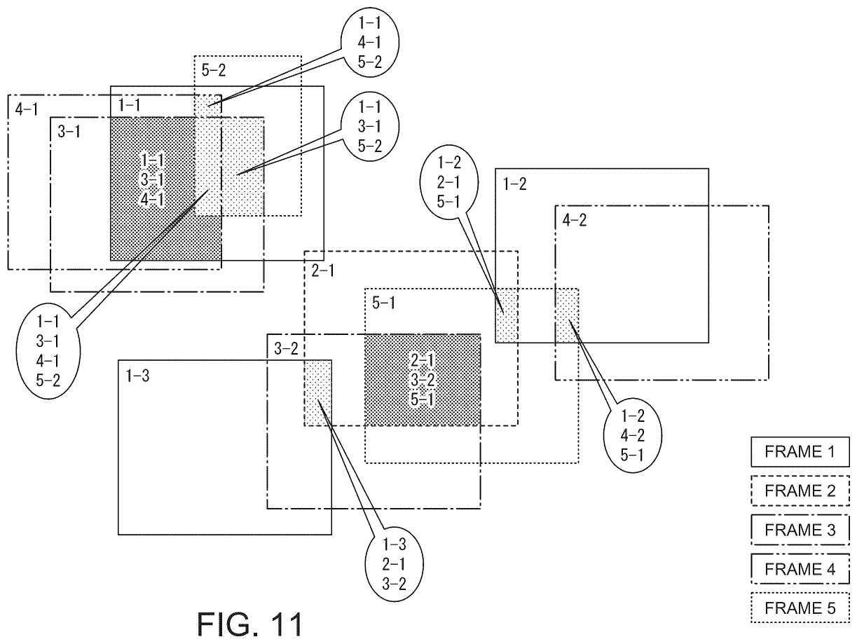

(Step S408) The mode setting unit 106 performs stability evaluation on each DR region (stability filter). In the stability evaluation, it is evaluated whether or not a common region having a predetermined frequency or more and a predetermined size or larger is occupied within a predetermined evaluation period up to the current time. Note that a region where a size of the common region is equal to or smaller than a predetermined size (for example, 200×200 pixels to 400×400 pixels) is excluded from the evaluation targets. In the example of FIG. 11, it is determined whether or not there is a region having a predetermined size or larger in three or more frames in a period within five frames up to the current time. In FIG. 11, 1-2 and the like indicate a second DR region of a first frame. The numbers of the DR regions generated in this period are 3, 1, 2, 2, and 2 in first, second, third, fourth, and fifth frames, respectively. Among the regions, regions shared over three or more frames are painted. Among the regions, a region painted with shading has a predetermined size or smaller and is thus excluded from the evaluation targets. The mode setting unit 106 is capable of determining a second DR region of the fourth frame and a first DR region of the fifth frame as stable DR regions as DR regions having a predetermined size or larger for three or more frames in the evaluation period. The mode setting unit 106 employs the DR region evaluated as stable as targets for subsequent processing and excludes the DR region that is not evaluated as stable from the targets for subsequent processing.

(Step S410) The mode setting unit 106 determines whether or not a DR region having a predetermined ratio (for example, 70% to 90%) or more is present in the display region of one application. When it is determined that the DR region is present (YES in step S410), the process proceeds to step S412. When it is determined that the DR region is not present (NO in step S410), the process proceeds to step S414.

(Step S412) The mode setting unit 106 determines whether or not the DR region having the predetermined ratio or more is present at the same position without moving. When it is determined that the DR region is present (YES in step S412), the process proceeds to step S418. When it is determined that the DR region is not present (NO in step S412), the process proceeds to step S416.

(Step S414) The mode setting unit 106 determines the entire display region as a 1-bit region.

(Step S416) The mode setting unit 106 determines the display region of the application that is being executed at the current time as a 1-bit region.

(Step S418) The mode setting unit 106 analyzes an image displayed in the DR region determined to be present at the same position to determine a 1-bit region. The DR region determined to be present at the same position is presumed to include a video image.

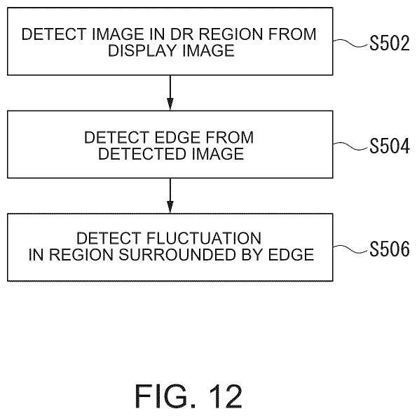

Next, a method of analyzing an image to determine a 1-bit region will be described. FIG. 12 is a diagram illustrating a fourth example of the determination method of the steady dynamic region according to one or more embodiments. FIG. 12 shows an example of a method of determining a 1-bit region in step S418 of FIG. 9 as the steady dynamic region.

(Step S502) The mode setting unit 106 detects, as an analysis target, the image in the DR region present at the same position from the display image.

(Step S504) The mode setting unit 106 executes known edge detection processing on the image serving as the analysis target to detect edges.

(Step S506) The mode setting unit 106 specifies a spatially continuous image region surrounded by the detected edges. When the image region surrounded by the edges is not capable of being specified, the mode setting unit 106 may specify a rectangular image region surrounded by four line segments oriented in a horizontal direction or in a vertical direction approximating the detected edges. The mode setting unit 106 specifies a region having a predetermined size or larger in the specified image region as a candidate for the 1-bit region.

The mode setting unit 106 determines whether or not a pixel change occurs in the specified image region. The pixel change means that a pixel where a fluctuation in gradation occurs is present. When there is a plurality of image regions in which the pixel change has occurred, the mode setting unit 106 may select the largest of these image regions. The mode setting unit 106 determines the image region in which the pixel change has occurred as a 1-bit region.

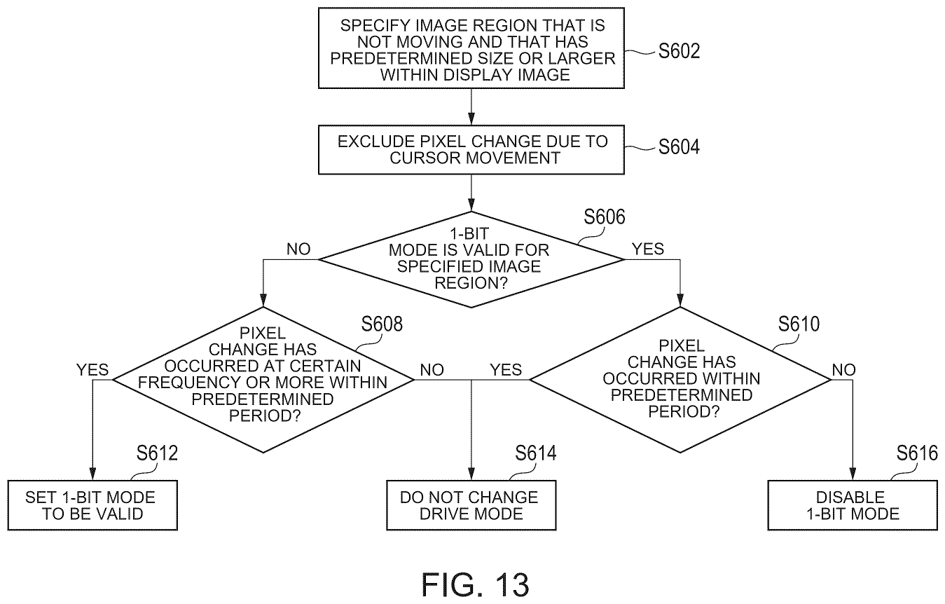

Next, a method of updating the setting of the steady dynamic region will be described. FIG. 13 is a diagram illustrating a setting method of the steady dynamic region according to one or more embodiments. In the example of FIG. 13, it is assumed that the 1-bit mode is set to be valid and the 4-bit mode is set to be invalid for the steady dynamic region, and the 4-bit mode is set to be valid and the 1-bit mode is set to be invalid for the non-steady dynamic region.

(Step S602) The mode setting unit 106 specifies an image region that is stationary and not moving and that has a predetermined size or larger within the display image. Here, the mode setting unit 106 may employ the image region determined by the process of step S506 in FIG. 12.

(Step S604) The mode setting unit 106 excludes the image region in which a pixel change due to the cursor movement is detected from the targets for processing. The pixel change due to the cursor movement is temporary and is predicted by the user operation, so that a decrease in image quality in this case is allowed.

(Step S606) The mode setting unit 106 determines whether or not the 1-bit mode is valid for the specified image region, that is, whether or not the specified image region is set as a 1-bit region. When it is determined that the 1-bit mode is valid (YES in step S606), the process proceeds to step S610. When it is determined that the 1-bit mode is invalid (NO in step S606), the process proceeds to step S608.

(Step S608) The mode setting unit 106 determines whether or not a pixel change has occurred at a certain frequency (for example, 60% to 80%) or more in a predetermined period (for example, 5 to 15 frames) immediately preceding the current time in the image region. When it is determined that the pixel change has occurred (YES in step S608), the process proceeds to step S612. When it is determined that the pixel change has not occurred (NO in step S608), the process proceeds to step S614.

(Step S610) The mode setting unit 106 determines whether or not a pixel change has occurred at least once in a predetermined period (for example, 5 to 15 frames) immediately preceding the current time in the image region. When it is determined that the pixel change has occurred (YES in step S610), the process proceeds to step S614. When it is determined that the pixel change has not occurred (NO in step S610), the process proceeds to step S616.

(Step S612) The mode setting unit 106 sets the 1-bit mode to be valid and disables the 4-bit mode for the specified image region.

(Step S614) The mode setting unit 106 does not change the drive mode for the specified image region.

(Step S616) The mode setting unit 106 disables the 1-bit mode and changes the 1-bit mode to the 4-bit mode for the specified image region.

As described above, the information processing system S1 according to one or more embodiments includes the host system 10 and the display unit 30, and the display unit 30 includes a controller (for example, the timing controller 32) and an electrophoretic display panel (for example, the EPD panel 34). The controller is configured to drive, with 1 bit, pixels arranged in a steady dynamic region in which display content dynamically fluctuates in a steady manner, and drive, with 2 bits or more, pixels arranged in the non-steady dynamic region, for the electrophoretic display panel, and the host system 10 is configured to determine, for an element of a display image to be displayed on the display unit 30, whether or not to determine a display region of the element as the steady dynamic region based on information on a dynamic characteristic of the element.

With this configuration, for the element of the display image, depending on the dynamic characteristic of the element, it is determined whether or not the display region is a steady dynamic region in which the display content is dynamically changed in a steady manner. In the steady dynamic region, the pixel is driven with 1 bit, and, in the non-steady dynamic region, the pixel is driven with 2 bits. Therefore, in the steady dynamic region, image fluctuations are represented with higher followability, and deterioration in image quality due to quantization is allowed. On the other hand, in the non-steady dynamic region, a display with subtle gradations is possible, and there is no need for the ability to follow a fluctuation in gradation. Therefore, depending on the dynamic characteristics of the elements constituting the display image, a steady dynamic region that corresponds to the ability to follow a fluctuation and a non-steady dynamic region that prioritizes image quality are used appropriately. Therefore, the user is capable of improving the subjective quality perceived as the entire display image without performing a complicated operation. In addition, since the refresh process is not necessarily required in the steady dynamic region in which the pixel is driven with 1 bit, the power consumption is capable of being reduced by restricting the target of the refresh process to the non-steady dynamic region, compared to a case where the refresh process is uniformly performed on the entire display region.

In addition, one or more embodiments may be implemented as follows.

The host system 10 may be configured to refer to a list (for example, a 1-bit app) indicating a predetermined application, and, when an application being executed is the predetermined application, determine a display region of an image of the application as the steady dynamic region.

The host system 10 may be configured to, when an operation indicating a motion operation of the display region (for example, a region of a window) is detected, determine the display region as the steady dynamic region.

The host system 10 may be configured to detect an update region (for example, a DR region) updated from a previous frame from a display image of a current frame, and select, as a candidate for the steady dynamic region, the update region that occurs at a predetermined frequency or more within a predetermined period up to the current frame and that has a common region having a predetermined size or larger (for example, stability filter).

The host system 10 may exclude an update region having a predetermined size or smaller from candidates for the steady dynamic region (for example, size filter).

The host system 10 may be configured to, when an area ratio of a candidate region that is the candidate for the steady dynamic region to the display image exceeds a predetermined area ratio, determine the entire display image as the steady dynamic region.

The host system 10 may be configured to, when an area ratio of a stationary update region to a candidate region that is the candidate for the steady dynamic region is equal to or less than a predetermined area ratio of the update region, detect edges from the candidate region, determine an image region whose gradation fluctuates within a predetermined period up to the current frame at a predetermined frequency or more among image regions surrounded by the detected edges, as the steady dynamic region, and exclude an image region whose gradation does not fluctuate within the predetermined period up to the current frame from the steady dynamic region.

One or more embodiments may be an information processing apparatus that includes the host system 10 and that causes the display unit 30 to display a display image, the display unit 30 including a controller (for example, the timing controller 32) configured to drive, with 1 bit, pixels arranged in a steady dynamic region, and drive, with 2 bits or more, pixels arranged in a non-steady dynamic region, for an electrophoretic display panel (for example, the EPD panel 34). The host system 10 determines, for an element of a display image to be displayed on the display unit 30, whether or not to determine a display region of the element as the steady dynamic region based on information on a dynamic characteristic of the element.

One or more embodiments may be a control method for the information processing system S1 including the host system 10 and the display unit 30, in which the display unit 30 includes a controller (for example, the timing controller 32) and an electrophoretic display panel (for example, the EPD panel 34), the control method including: via the controller, driving, with 1 bit, pixels arranged in a steady dynamic region, and driving, with 2 bits or more, pixels arranged in a non-steady dynamic region, for the electrophoretic display panel; and, via the host system 10, determining, for an element of a display image to be displayed on the display unit 30, whether or not to determine a display region of the element as the steady dynamic region based on information on a dynamic characteristic of the element.

Although the embodiments of the present invention have been described in detail with reference to the drawings, the specific configurations are not limited to the above-described embodiments, and the present application includes designs and the like within a scope not departing from the spirit of the invention. It is possible to optionally combine the configurations described in the above-described embodiments.

### DESCRIPTION OF SYMBOLS

S1 information processing system
10 host system
12 processor
14 main memory
20 chipset
22 auxiliary storage medium
30 display unit
32 timing controller
34 EPD panel
40 input device
102 OS processing unit
104 application execution unit
106 mode setting unit
108 graphic processing unit
322 quantization unit
324 dithering unit
326 drive signal generation unit

What is claimed is:

1. An information processing system comprising:
a host system; and
a display unit,
wherein the display unit
includes a controller and an electrophoretic display panel,
the controller is configured to
drive, with 1 bit, pixels arranged in a steady dynamic region in which display content dynamically fluctuates in a steady manner, and drive, with 2 bits or more, pixels arranged in a non-steady dynamic region, for the electrophoretic display panel, and
the host system is configured to
determine, for an element of a display image to be displayed on the display unit, whether or not to determine a display region of the element as the steady dynamic region based on information on a dynamic characteristic of the element.

2. The information processing system according to claim 1,
wherein the host system is configured to
refer to a list indicating a predetermined application, and
when an application being executed is the predetermined application, determine a display region of an image of the application as the steady dynamic region.

3. The information processing system according to claim 1,
wherein the host system is configured to
when an operation indicating a motion operation of the display region is detected, determine the display region as the steady dynamic region.

4. The information processing system according to claim 1,
wherein the host system is configured to
detect an update region updated from a previous frame from a display image of a current frame, and
select, as a candidate for the steady dynamic region, the update region that occurs at a predetermined frequency or more within a predetermined period up to the current frame and that has a common region having a predetermined size or larger.

5. The information processing system according to claim 4,
wherein the host system is configured to
exclude the update region having a predetermined size or smaller from candidates for the steady dynamic region.

6. The information processing system according to claim 4,
wherein the host system is configured to
when an area ratio of a candidate region that is the candidate for the steady dynamic region to the display image exceeds a predetermined area ratio, determine an entire display image as the steady dynamic region.

7. The information processing system according to claim 4,
wherein the host system is configured to, when an area ratio of a stationary update region to a candidate region that is the candidate for the steady dynamic region is equal to or less than a predetermined area ratio of the update region,
detect edges from the candidate region,
determine an image region whose gradation fluctuates within a predetermined period up to the current frame at a predetermined frequency or more among image regions surrounded by the edges, as the steady dynamic region, and
exclude an image region whose gradation does not fluctuate within the predetermined period up to the current frame from the steady dynamic region.

8. An information processing apparatus comprising:
a host system,
wherein the information processing apparatus causes a display unit to display a display image, the display unit including a controller configured to drive, with 1 bit, pixels arranged in a steady dynamic region in which display content dynamically fluctuates in a steady manner, and drive, with 2 bits or more, pixels arranged in a non-steady dynamic region, for an electrophoretic display panel, and
the host system is configured to
determine, for an element of the display image to be displayed on the display unit, whether or not to determine a display region of the element as the steady dynamic region based on information on a dynamic characteristic of the element.

9. A control method for an information processing system including a host system and a display unit,
in which the display unit includes
a controller and an electrophoretic display panel,
the control method comprising:
via the controller,
driving, with 1 bit, pixels arranged in a steady dynamic region in which display content dynamically fluctuates in a steady manner, and driving, with 2 bits or more, pixels arranged in a non-steady dynamic region, for the electrophoretic display panel; and
via the host system,
determining, for an element of a display image to be displayed on the display unit, whether or not to determine a display region of the element as the steady dynamic region based on information on a dynamic characteristic of the element.
